(19) United States
(12) Patent Application Publication
(10) Pub. No.: US 2026/0070547 A1
(43) Pub. Date: Mar. 12, 2026

(54) VEHICLE CONTROL DEVICE AND VEHICLE CONTROL METHOD

(71) Applicants: HYUNDAI MOTOR COMPANY, Seoul (KR); KIA CORPORATION, Seoul (KR)

(72) Inventor: Sang Ho Shin, Hwaseong-si (KR)

(73) Assignees: HYUNDAI MOTOR COMPANY, Seoul (KR); KIA CORPORATION, Seoul (KR)

(21) Appl. No.: 19/259,172

(22) Filed: Jul. 3, 2025

(30) Foreign Application Priority Data
Sep. 12, 2024 (KR) 10-2024-0124790

(51) Int. Cl. B60W 30/14; B60W 10/04; B60W 10/18; B60W 20/12

(52) U.S. Cl. CPC B60W 30/143; B60W 10/04; B60W 10/18; B60W 20/12; B60W 2510/244; B60W 2530/209; B60W 2552/15; B60W 2554/802; B60W 2556/50; B60W 2720/106

(57) ABSTRACT

A vehicle control device according to an embodiment of the present specification includes: a vehicle controller that determines a driving torque or a regenerative braking torque in accordance with a demand driving force or a demand braking force, and outputs a torque command according to this; a navigation system; an instrument cluster that displays a DTE; and a control unit that controls the vehicle controller to cause a vehicle to travel at a target speed set by a user, and, in a case where the speed is accelerated or decelerated according to a pre-set condition, adjusts an acceleration level and a deceleration level based on information on the DTE displayed on the instrument cluster and a charging station distance obtained by the navigation.

### CROSS-REFERENCE TO RELATED APPLICATION

The present application claims priority to Korean Patent Application No. 10-2024-0124790, filed on Sep. 12, 2024, the entire contents of which is incorporated herein by reference in its entirety for all purposes.

### TECHNICAL FIELD

The present disclosure relates to a vehicle control device and a vehicle control method.

### BACKGROUND

Recently, studies on an advanced driver assist system (ADAS) that provides a traveling assist function based on information on a state of a vehicle, a state of a driver, and a surrounding environment have been actively conducted to reduce a driver's burden and enhance convenience.

The advanced driver assist system (ADAS) can provide cruise control. A cruise control function is a function that allows a vehicle to drive at a constant speed without a driver's operation of an accelerator pedal, and can provide a smart cruise control (SCC) function that implements smart cruise control, a navigation-based smart cruise control (NSCC) function that implements navigation-based smart cruise control, and the like. SCC is a function that helps a vehicle travel at a speed set by a driver while maintaining a distance from a vehicle in front during traveling. NSCC is a function for travel convenience, which helps a vehicle travel at a safe speed in accordance with a road situation.

When SCC or NSCC control is implemented, the vehicle can travel at a target speed set by a user, and can implement accelerated or decelerated travel according to a distance from a vehicle in front, a speed limit of a road, and the like. As such, when the accelerated or decelerated travel is implemented, a fuel consumption amount can be different compared to when constant-speed travel is implemented at a target speed. Therefore, there is a need for a function that manages a distance to empty (DTE) during implementing an SCC or NSCC function.

### SUMMARY

An object of an embodiment of the present specification is to provide a vehicle control device and a vehicle control method that can ensure a distance to empty (DTE) and compensate for a deficient DTE during smart cruise control (SCC) or navigation-based smart cruise control (NSCC).

A technical task or effect that an embodiment of the present specification is to achieve is not limited to any technical task or effect mentioned herein, and other technical tasks or effects that have not been mentioned should be clearly understood by those having ordinary skill and knowledge in the technical field to which the present disclosure belongs from the description below.

A vehicle control device according to an embodiment of the present specification includes a vehicle controller that determines a driving torque or a regenerative braking torque in accordance with a demand driving force or a demand braking force, and outputs a torque command according to the driving torque or the regenerative braking torque. The vehicle control device also includes a navigation, an instrument cluster that displays a distance to empty (DTE), and a control unit that controls the vehicle controller to cause a vehicle to travel at a target speed, and, in a case where a speed of the vehicle is accelerated or decelerated according to a pre-set condition, adjusts an acceleration level and a deceleration level based on information on the DTE displayed on the instrument cluster and a charging station distance obtained by the navigation.

A vehicle control method according to an embodiment of the present specification includes a step of checking whether or not at least any one of a smart cruise control (SCC) function and navigation-based smart cruise control (NSCC) function is being implemented, a step of, in a case where the at least any one of the SCC function and the NSCC function is being implemented, checking whether or not state of charge (SOC) information of a battery is received from a battery management system, and a step of, in a case where reception of the SOC information is failed, adjusting an acceleration level and a deceleration level based on information on a distance to empty (DTE) displayed on an instrument cluster and a charging station distance obtained by a navigation.

An embodiment of the present specification has at least the following effects.

A vehicle control device and a vehicle control method according to an embodiment of the present specification can ensure a DTE and compensate for a deficient DTE during smart cruise control (SCC) or navigation-based smart cruise control (NSCC).

A vehicle control device and a vehicle control method according to an embodiment of the present specification can ensure a DTE by decreasing an acceleration level for achieving a target speed to a value less than a normal control value and thereby reducing battery consumption for acceleration. Further, the disclosed vehicle control device and vehicle control method can ensure a DTE by raising a deceleration level for achieving a target speed to a value more than the normal control value, increasing a regenerative braking amount, and thereby increasing a battery charge amount, during SCC/NCC control.

A vehicle control device and a vehicle control method according to an embodiment of the present specification can further ensure a DTE by ensuring a regenerative braking charge amount by regenerative braking amount control due to a gradient of a road during SCC/NCC control.

Effects according to an embodiment of the present specification are not limited by the description herein, and other various effects are included in the present specification.

### BRIEF DESCRIPTION OF THE DRAWINGS

FIG. 1 is a control block diagram of a vehicle control device according to an embodiment of the present specification.

FIG. 2 is a flowchart of a vehicle control method according to a first embodiment of the present specification.

FIG. 3 is a graph for describing control setting values during vehicle control of FIG. 2.

FIG. 4 is a flowchart of a vehicle control method according to a second embodiment of the present specification.

FIG. 5 is a graph for describing control setting values during regenerative braking of FIG. 4.

### DETAILED DESCRIPTION

Hereinafter, the present disclosure is described in detail with reference to embodiments, and is described in detail referring to attached drawings to help understanding of the disclosure. When it is determined that specific description about the known related art in describing embodiments disclosed in the present specification blurs the gist of embodiments disclosed in the present specification, the detailed description is omitted. In addition, the attached drawings are provided only for easy understanding of embodiments disclosed in the present specification, do not limit the technical idea disclosed the present specification, and should be understood to include all modifications, equivalents, and replacements included in the idea and technical scope of the present disclosure.

Terms including ordinals such as “first”, “second”, and the like may be used to describe various elements, but the elements are not limited by the terms. The terms are used only as name meaning for distinguishing one element from another element, and sequential meaning between the elements are understood not from the name but from the context of the description.

When it is mentioned that an element is “connected” or “linked” to another element, it should be understood that the element may be directly connected or linked to another element, but another element may exist in between. On the other hand, when it is mentioned that an element is “directly connected” or “directly linked” to another element, it should be understood that another element may not exist in between.

Singular expressions include plural expressions, unless the context clearly indicates otherwise.

In the present application, it should be understood that the term “include” or “have” indicates that a feature, a number, a step, an operation, a component, a part, or a combination thereof described in the specification exists, but does not exclude the possibility of existence or addition of one or more other features, numbers, steps, operations, components, parts, or combinations thereof in advance. When a component, device, element, or the like of the present disclosure is described as having a purpose or performing an operation, function, or the like, the component, device, or element should be considered herein as being “configured to” meet that purpose or to perform that operation or function. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, embodiments disclosed in the present specification are described with reference to drawings, and the same or like components are given with the same reference numerals and overlapping description thereof is omitted.

Furthermore, the term unit or control unit included in the name of hybrid control unit (HCU), vehicle control unit (VCU), and the like is a term widely used for naming a controller that commands a specific function of a vehicle, and does not mean a generic function unit. For example, each controller may include a communication device that communicates with another controller or sensor to control a corresponding function, a memory that stores an operating system or a logic command, input/output information, and the like, and one or more processors that perform judgement, calculation, determination, and the like necessary for controlling the corresponding function.

Before describing the vehicle control device and the vehicle control method according to an embodiment of the present disclosure, a configuration of a vehicle applicable to embodiments disclosed herein is described first. A vehicle that implements control of a smart cruise control function mentioned in the description below is assumed to be a hybrid electric vehicle, but it is understood for those having ordinary skill in the art that embodiments of the present disclosure can be applied regardless of a power train configuration such as a vehicle provided with general internal combustion engine and an electric vehicle, except for the application of a generative brake function in deceleration (i.e., regenerative braking).

A hybrid electric vehicle (HEV) generally refers to a vehicle that generally uses two types of power sources, and the two types of power sources are mainly an engine and an electric motor. The hybrid electric vehicle can operate in two types of travel modes depending on which power train is driven. One is an electric vehicle (EV) mode that travels only by an electric motor, and the other is a hybrid electric vehicle (HEV) mode that operates an electric motor and an engine together. The hybrid electric vehicle can implement switching between two modes in accordance with a condition during traveling. Such switching between travel modes is generally implemented for the purpose of maximizing fuel efficiency or driving efficiency, depending on efficiency characteristics of the power train.

According to an embodiment of the present specification, it is possible to ensure a DTE by decreasing an acceleration level for achieving a target speed to a value less than a normal control value and thereby reducing battery consumption for acceleration. It is also possible, according to an embodiment of the present disclosure, to ensure a DTE by increasing a deceleration level for achieving a target speed to a value more than the normal control value, increasing a regenerative braking amount, and thereby increasing a battery charge amount, during smart cruise control (SCC) or navigation-based smart cruise control (NSCC). In addition, it is possible to further ensure a DTE by ensuring a regenerative braking charge amount by a regenerative braking amount control due to a gradient of a road where a vehicle is traveling during SCC/NCC control.

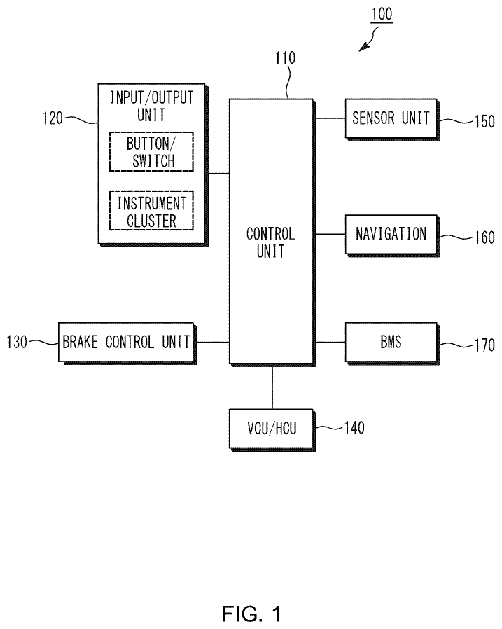

FIG. 1 is a control block diagram for a vehicle control device according to an embodiment of the present specification. The vehicle control device according to an embodiment of the present disclosure can be embodied in an interior of a vehicle. In this example, the vehicle control device can be integrally formed with internal control units of the vehicle, or can be embodied as a separate device and connected to control units of the vehicle by separate connection means.

With reference to FIG. 1, a vehicle control device (100) according to an embodiment of the present specification can include an input/output unit (120), a brake control unit (130), a VCU/HCU (140), a sensor unit (150), a navigation or navigation system (160), a battery management system (hereinafter, referred to as BMS) (170), and a control unit (110). FIG. 1 mainly illustrates components related to the present embodiment, and the actual vehicle control device (100) can include components less than or more than this.

The input/output unit (120) can include an input unit for a user's input and a display unit to display information. The input unit can include a button/switch and the like, and the button/switch can be provided in the form of a touch screen. For example, there can be provided with a cruise control switch to turn on or off operation of cruise control for a driver to set a desired vehicle speed as a constant travel vehicle speed. The display unit can include an instrument cluster and the like. The instrument cluster may be a dashboard that is provided in an interior of a vehicle and displays information related to travel of the vehicle, can display a speed, RPM, a fuel amount, and the like, and can display a DTE.

The brake control unit (130) can be configured to control braking of a vehicle, and can include a controller that controls a brake.

As for the VCU/HCU (140), depending on the type of the vehicle, a vehicle control unit (VCU) plays the role of the VCU/HCU in a case of an electric vehicle, and a hybrid control unit (HCU) plays the role of the VCU/HCU in a case of a hybrid electric vehicle. The VCU/HCU (140) can determine a demand driving force of a vehicle in accordance with a value of an accelerator pedal sensor value, and can determine a demand braking force in accordance with a value of a brake pedal position sensor (BPS). The VCU/HCU (140) can determine a driving torque or a regenerative braking torque in accordance with the demand driving force or the demand braking force, and can output a torque command according to this. The VCU/HCU (140) can determine a driving torque or a regenerative braking torque in accordance with a demand driving force or a demand braking force of the control unit (110) in a cruise control operation without pedal operation.

The sensor unit (150) includes various sensors, and can obtain travel information of a vehicle and information on a surrounding of a vehicle. For example, the sensor unit (150) can include a vehicle speed sensor, a steering angle sensor, a yaw rate sensor, an accelerator pedal sensor, a brake pedal sensor, a distance sensor, a video sensor, and the like. The vehicle speed sensor may be a sensor that senses a travel speed of a vehicle, a steering angle sensor may be a sensor that senses a rotary torque of a steering wheel, and a yaw rate sensor may be a sensor that detects a yaw rate of a vehicle in a vertical axis direction. The accelerator pedal sensor may be a sensor that senses a pressure that a driver imposes on the accelerator pedal, and the brake pedal sensor may be a sensor that senses a pressure that a driver imposes on the brake pedal. The distance sensor can obtain information on a surrounding of a vehicle. More specifically, the distance sensor can sense an object outside a vehicle and can calculate a distance between the vehicle and the object. The distance sensor can include a radar, a light detection and ranging (lidar), or the like. The video sensor can obtain an image outside the vehicle. The video sensor can include one or more cameras that obtain a video outside the vehicle.

The navigation (160) can obtain road traffic information, road topography information, surrounding environment information and the like and provide the control unit (110) with the information. The road traffic information can include speed limit information, vehicle speed change section information (for example, curved road, tollgate, or the like), an accident black section (for example, a road location or section with a significantly higher-than-average accident rate), accident information, and the like. The road topography information can include gradient information of a road where a vehicle is traveling. In addition, the navigation (160) can obtain charging station location information in a traveling region, and provide information on a distance between the charging station and a current location.

The BMS (170) can comprehensively check information on voltage, current, and temperature of internal cells of a battery. The BMS (170) can manage a charge state based on a state of charge (SOC). The BMS (170) can manage a charge state of a battery such that a voltage of the battery is not discharged to be equal to or less than a limit voltage (i.e., low limit voltage) or charged to be equal to or more than another limit voltage (i.e., high limit voltage). The BMS (170) can calculate a charge permissible amount of the battery based on the SOC of the battery.

The control unit (110) can implement the vehicle control method according to an embodiment of the present specification by transmitting/receiving data among the input/output unit (120), the brake control unit (130), the VCU/HCU (140), the sensor unit (150), the navigation (160), and the BMS (170). The control unit (110) and each component can transmit/receive various data through a communication interface with vehicle controllers connected to a vehicle network, for example, a controller area network (CAN) communication.

The control unit (110) may be a control unit of an advanced driver assistance system (ADAS) that provides smart cruise control (SCC) or navigation-based smart cruise control (NSCC). The cruise control is a function that, when a driver sets a desired optional traveling speed in a state of traveling on an expressway or a road for exclusive use of automobiles, allows a vehicle to drive constantly at a target speed set by the driver by automatically adjusting an air quantity and a fuel quantity without the driver's operation of an accelerator pedal. The SCC is a function that helps a vehicle travel at a speed set by a driver while maintaining a distance from a vehicle in front during traveling. Therefore, when the SSC function is implemented, a vehicle can travel in a method of performing acceleration or deceleration to maintain a specific distance from a vehicle in front and then returning to a speed set by a driver. The NSCC is a function for travel convenience, which helps a vehicle travel at a safe speed in accordance with a road situation during traveling on an expressway or a road for exclusive use of automobiles. For example, a vehicle can travel in a method of automatically performing deceleration before entering into a safe speed section and then automatically returning to a speed set before entering such section.

The control unit (110) of the vehicle control device according to an embodiment of the present specification causes a vehicle to travel at a target speed, and, in a case where the control unit (110) should implement a function of performing deceleration or acceleration, can adjust an acceleration level and a deceleration level based on information on a DTE displayed on an instrument cluster and a charging station distance, and can charge a battery by regenerative braking. In the description below, a case where an SCC function or an NSCC function is operated is an example of a case where a vehicle travels at a target speed and should implement a function of performing deceleration or acceleration, but the present disclosure is not limited thereto.

In a case where the SCC/NSCC function is being operated, the control unit (110) can adjust an acceleration level and a deceleration level based on information on a DTE displayed on the instrument cluster and a charging station distance, and can charge a battery by regenerative braking. In this example, the control unit (110) checks whether or not a state of charge (SOC) of a battery can be obtained via a communication with the BMS (170), and, in a case where the SOC communication with the BMS (170) is failed, can select adjustment of an acceleration level and a deceleration level based on information on a DTE displayed on the instrument cluster and a charging station distance.

In a case where a ratio of a charging station distance to a DTE is equal to or less than a specific level, the control unit (110) can ensure a DTE by adjusting an acceleration level and a deceleration level and minimizing consumption of a battery due to the SCC/NSCC function. For example, in a case where a ratio of a charging station distance to a DTE is equal to or less than a specific level, it is possible to reduce battery consumption by decreasing an acceleration level and a deceleration level.

In addition, the control unit (110) can further ensure a DTE by charging a battery by implementing regenerative braking due to a gradient of a road where a vehicle is traveling, which is obtained by the navigation (160).

Each of elements that constitute the vehicle control device (100) according to embodiments described above is not necessarily intended to refer to a separate device that is physically distinguished from one another. In other words, hardware that constitutes the vehicle control device is merely functionally distinguished by an operation implemented by the hardware, but each of the units should not be necessarily provided independently from one another, and can be embodied by being integrated into one piece of hardware or embodied by being divided into two or more devices by the function and can be embodied in various forms of hardware or software.

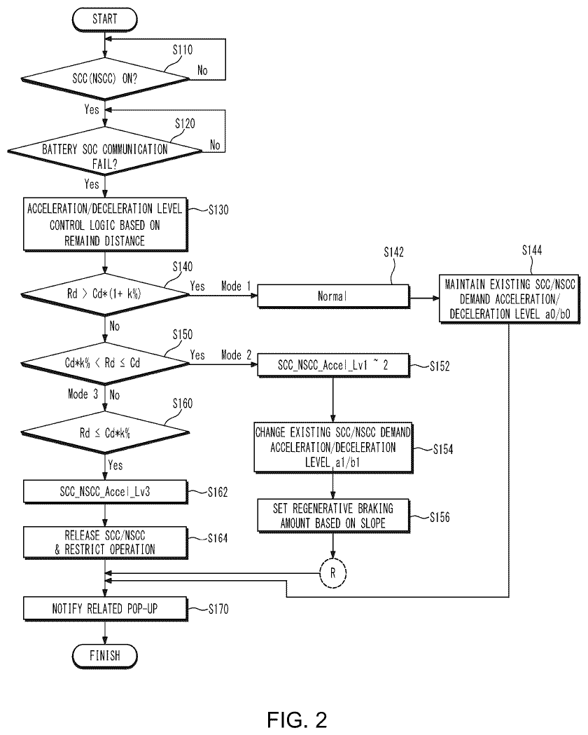

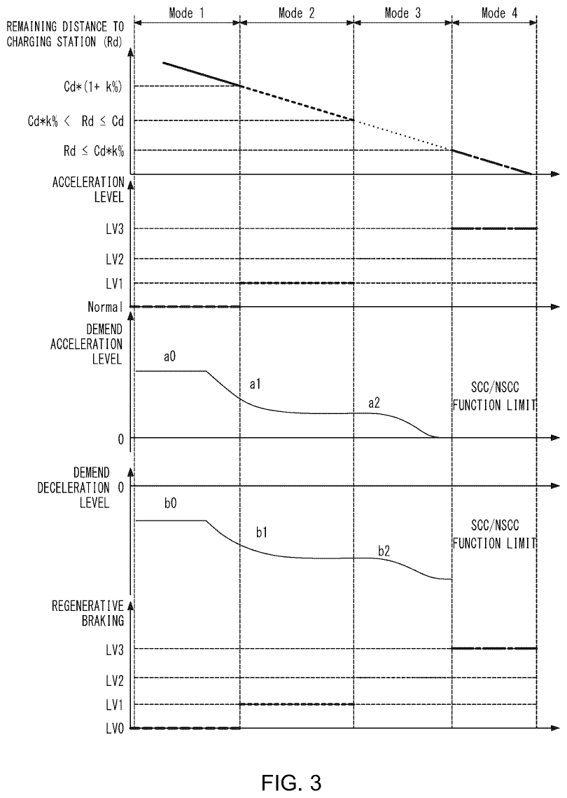

FIG. 2 is a flowchart of a vehicle control method according to a first embodiment of the present specification, and FIG. 3 is a graph for describing a method of determining a control mode during vehicle control of FIG. 2. The first embodiment of the present specification according to FIGS. 2 and 3 illustrates a method of controlling an acceleration level and a deceleration level during operation of an SCC/NSCC function.

With reference to FIGS. 2 and 3, the vehicle control device (100) causes a vehicle to travel at a target speed and determines whether or not a function of performing deceleration and acceleration should be implemented. For example, the vehicle control device (100) can determine whether or not the SCC function or the NSCC function is being operated (S110).

In a case where the SCC function or the NSCC function is being operated, the control unit (110) checks whether or not SOC communication with the BMS (170) has failed (S120).

When the SOC communication has failed, it is possible to implement a logic of controlling an acceleration level/deceleration level based on DTE information (S130). In other words, in a case where it is not possible to receive SOC information due to SOC communication abnormality, the control unit (11) enters into a fail safety mode, and can ensure a DTE by adjusting an acceleration level and a deceleration level based on a DTE (a remainder distance, or simply Rd) displayed on an instrument cluster and a charging station distance (Cd) provided by the navigation (160) and minimizing consumption of a battery. With reference to FIG. 3, the vehicle control device (100) can compare the DTE (Rd) to a charging station with first to third standard distances (R1, R2, R3) and determine an SCC/NSCC control mode from any one of first to fourth modes (Mode 1, Mode 2, Mode 3, Mode 4) for operation.

With reference to FIGS. 2 and 3, the vehicle control device (100) determines whether or not the DTE (Rd) exceeds a first standard value (R) (S140). The first standard value (R1) can be calculated by using the charging station distance (Cd) and a ratio (k) of the charging station distance (Cd) to the DTE (Rd). For example, the ratio (k) between the two distances can be calculated based on the DTE (Rd) and the charging station distance (Cd) (k: Rd/Cd ratio ex) (30%→Rd=90 km, Cd=30 km).

When the DTE (Rd) exceeds the first standard value (R1), the vehicle control device (100) enters into a first mode (Mode 1) and determines the acceleration level as a normal level (Normal) (S142).

When the acceleration level is determined to be a normal level (Normal), the existing set demand acceleration level (a0)/deceleration level (b0) is maintained at the time of operating the SCC/NSCC function (S144). When the DTE (Rd) exceeds the first standard value (R), it can be seen as a state where traveling to the charging station is possible enough, and thus the vehicle control device (100) can enter into the first mode (Mode 1) and cause the vehicle to travel in accordance with the existing demand acceleration level (a0)/deceleration level (b0). Since regenerative braking is also not necessary, L0 level where regenerative braking is not implemented is set to implement the SCC/NSCC function.

In step S140, when it is determined that the DTE (Rd) is equal to or less than the first standard value (R1), it is determined whether or not the DTE (Rd) is equal to or less than the first standard value (R1) and exceeds the second standard value (R2) (Cd*k%<Rd≤Cd) (S150). In this example, the ratio (k) between the two distances can be calculated based on the DTE (Rd) and the charging station distance (Cd) as in step S140. A state where the DTE (Rd) is equal to or less than the first standard value (R1) and exceeds the second standard value (R2) can be set within a range where the DTE (Rd) is equal to or less than the charging station distance (Cd), but the vehicle can travel to the charging station by minimizing the battery consumption and charging the battery by regenerative braking.

When the DTE (Rd) satisfies a condition of being equal to or less than the first standard value (R1), and exceeding the second standard value (R2), the vehicle control device (100) can enter into the second mode (Mode 2) or the third mode (Mode 3) and determine the acceleration level as a first level (SCC_NSCC_Accel_Lv1) or a second level (SCC_NSCC_Accel_Lv2) (S152).

When the acceleration level is determined as the first level (SCC_NSCC_Accel_Lv1) or the second level (SCC_NSCC_Accel_Lv2), the existing set demand acceleration level (a0)/deceleration level (b0) can be lowered to a1/b1 or lowered to a2/b2 at the time of operating the SCC/NSCC function. As described above, in a case where the DTE (Rd) is between the first standard value (R1) and the second standard value (R2), it is possible to ensure the DTE by reducing the battery consumption by lowering the acceleration level for meeting a target vehicle speed to less than a normal control value (a0→a1). In addition, it is possible to ensure the DTE by increasing the battery charge amount by increasing the regenerative braking amount by raising the acceleration level for meeting a target vehicle speed to more than a normal control value (b0→b1).

In the second mode (Mode 2) or the third mode (Mode 3), it is possible to set a regenerative braking amount in accordance with a slope of a road where a vehicle is traveling by also implementing a regenerative braking function (S156). It is possible to further ensure the DTE by ensuring a charge amount of the battery by implementing regenerative braking in accordance with the gradient of the road where the vehicle is traveling. In this example, a step R of determining a regenerative braking amount in accordance with a slope is described in detail below.

In step S150, when the DTE (Rd) is equal to or less than the first standard value (R1) and departs from a range of exceeding the second standard value (R2), it is determined whether or not the DTE (Rd) is equal to or less than the second standard value (R2) (Rd≤Cd*k %) (S160). When the DTE (Rd) is equal to or less than the second standard value (R2), this may be a state where it is hard for the vehicle to reach the charging station at the time of implementing the SCC/NSCC function.

When the DTE (Rd) is equal to or less than the second standard value (R2), the vehicle control device (100) enters into a fourth mode (Mode 4), and the acceleration level can be determined as a third level (SCC_NSCC_Accel_Lv3) (S162).

When the acceleration level is determined as the third level (SCC_NSCC_Aceel_Lv3), it is possible to release the SCC/NSCC function or restrict operation thereof (S164).

The control process described above can be notified (i.e., displayed to a user/driver) using a related pop-up message (S170).

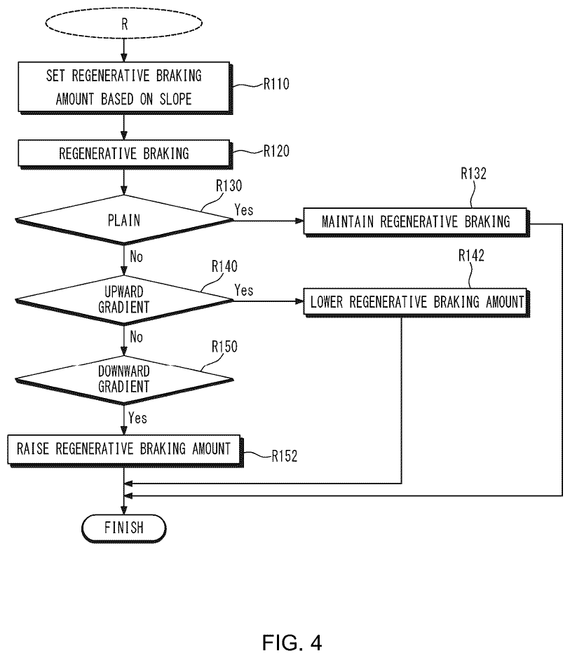

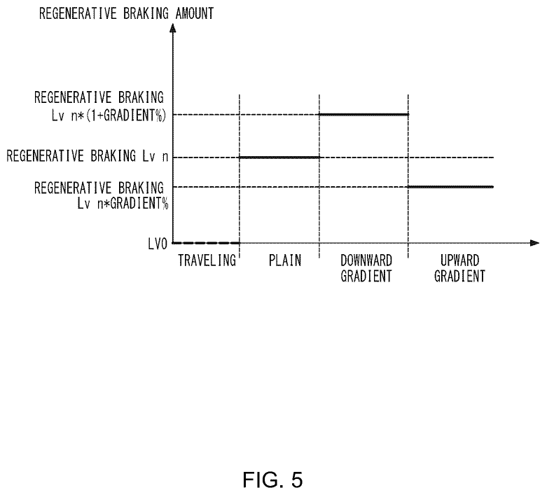

Hereinafter, with reference to FIGS. 4 and 5, the step R of determining a regenerative braking amount in accordance with a slope (refer to FIG. 2) is described in detail. FIG. 4 is a flowchart of a vehicle control method according to a second embodiment of the present specification, and FIG. 5 is a graph for describing the vehicle control method of FIG. 4, which illustrates a method of calculating a regenerative braking amount in accordance with a gradient angle.

The step R of determining a regenerative braking amount can be implemented in a case where the DTE (Rd) satisfies a condition of being less than or equal to the first standard value (R1) and exceeding the second standard value (R2) and the SCC/NSCC control mode enters into the second mode (Mode 2) or the third mode (Mode 3).

When the SCC/NSCC mode enters into the step R of determining a regenerative braking amount, setting of the regenerative braking amount in accordance with a gradient of the slope is started (R110).

It is possible to set a regenerative braking level to a first level (Lv1) or a second level (Lv2) (R120). The regenerative braking level can be set in a case where the DTE (Rd) satisfies a condition of being equal to or less than the first standard value (R1) and exceeding the second standard value (R2) and the SCC/NSCC mode enters into the second mode (Mode 2) or the third mode (Mode 3). When the regenerative braking level is set to the first level (Lv1) or the second level (Lv2), as illustrated in FIG. 5, it is possible to adjust the regenerative braking amount in accordance with a gradient of a road.

First, it is determined whether or not the road where the vehicle is traveling has a gradient of 0 (R130). As used herein, a gradient of zero (0) means the road is flat or plain.

In a case where the road is a plain road (i.e., flat road), it is possible to maintain a regenerative braking amount set by a particular regenerative braking level (R132).

In a case where the road is not a plain road, it is determined whether or not the slope is an upward slope (i.e., uphill road) (R140).

In a case where the slope is an upward slope (Yes at R140), the regenerative braking amount set by the particular regenerative braking level is lowered (R142). When the regenerative braking amount is excessive for the upward slope, vehicle pitching may become excessive. Therefore, adjustment can be made to reduce the regenerative braking amount by a value of a gradient angle of the road compared to the regenerative braking amount set by the particular regenerative braking level. For example, when a gradient is 3% in the case of an upward slope (hill climbing), adjustment can be made to reduce the regenerative braking amount by 3%, and when the gradient is 9%, adjustment can be made to reduce the regenerative braking amount by 9%.

In a case where the slope is not an upward slope (No in R140), it is determined whether or not the slope is a downward slope (i.e., downhill road) (R150).

In a case where the slope is a downward slope, the regenerative braking amount set by the particular regenerative braking level is raised (R152). In the case of the downward slope, adjustment can be made to increase the regenerative braking amount by a value of a gradient angle of the road compared to the regenerative braking amount set by the particular regenerative braking level. For example, when a gradient is 3% in the case of a downward slope (hill descending), adjustment can be made to increase the regenerative braking amount by 3%, and when the gradient is 9%, adjustment can be made to increase the regenerative braking amount by 9%. As described herein, it is possible to maximize a charge amount of a battery by increasing a regenerative braking amount on a downward slope.

Hereinabove, embodiments of the present specification have been described in detail with reference to the attached drawings, but the present specification is not necessarily limited to such embodiments, and can be variously modified and implemented within a range of not departing from the technical idea of the present specification. Therefore, the embodiments disclosed in the present specification are not intended to restrict the technical idea of the present specification but to describe thereof, and the embodiments described herein do not restrict the range of the technical idea of the present specification. Therefore, the above-mentioned detailed description should be considered not to be limited but illustrative in every aspect. The protection scope of the present specification should be construed by the scope of the claims, and all technical ideas within the equivalent range should be construed to be included in the scope of the present specification.
100: Vehicle control device
110: Control unit
120: Input/output unit
130: Brake control unit
140: Vehicle control unit (VCU)/hybrid control unit (HCU)
150: Sensor unit
160: Navigation or Navigation system
170: Battery management system (BMS)

What is claimed is:

1. A vehicle control device comprising:
a vehicle controller configured to determine a driving torque or a regenerative braking torque in accordance with a demand driving force or a demand braking force, and configured to output a torque command according to the driving torque or the regenerative braking torque;
a navigation system;
an instrument cluster configured to display a distance to empty (DTE); and
a control unit configured to control the vehicle controller to cause a host vehicle to travel at a target speed, and, in a case where a speed of the host vehicle is accelerated or decelerated according to a pre-set condition, configured to adjust an acceleration level and a deceleration level based on information on the DTE displayed on the instrument cluster and a charging station distance obtained by the navigation system.

2. The vehicle control device according to claim 1,
wherein the instrument cluster further includes a battery management system configured to provide information on a state of charge (SOC) of a battery, and
wherein the control unit is configured to adjust the acceleration level and the deceleration level based on the information on the DTE and the charging station distance, based on whether the control unit fails to communicate with the battery management system.

3. The vehicle control device according to claim 1,
wherein the control unit is configured to lower the acceleration level and the deceleration level to a value lower than pre-set values, based on whether the DTE is equal to or less than a standard value based on the charging station distance.

4. The vehicle control device according to claim 1,
wherein the control unit is configured to calculate a first standard value and a second standard value less than the first standard value based on the DTE and the charging station distance, and, based on whether the DTE is equal to or less than the first standard value and exceeds the second standard value, the control unit is configured to lower the acceleration level and the deceleration level to be lower than pre-set values.

5. The vehicle control device according to claim 4,
wherein the control unit is configured to set the acceleration level and the deceleration level to the pre-set values, based on whether the DTE exceeds the first standard value.

6. The vehicle control device according to claim 4,
wherein the control unit is configured to issue a battery shortage warning based on the DTE being equal to or less than the second standard value.

7. The vehicle control device according to claim 4,
wherein the control unit is configured to implement a regenerative braking for the deceleration level for deceleration to charge a battery, based on the DTE being equal to or less than the first standard value and exceeding the second standard value.

8. The vehicle control device according to claim 4,
wherein the control unit is configured to adjust a regenerative braking amount in accordance with a gradient of a road obtained by the navigation system, based on the DTE being equal to or less than the first standard value and exceeding the second standard value.

9. The vehicle control device according to claim 8,
wherein the control unit is configured to decrease the regenerative braking amount in accordance with the gradient of the road based on the gradient of the road being an upward gradient, and configured to increase the regenerative braking amount in accordance with the gradient of the road based on the gradient of the road being a downward gradient.

10. The vehicle control device according to claim 1, further comprising:
a sensor unit configured to sense a distance from an adjacent vehicle,
wherein the control unit is configured to decelerate or accelerate a speed to maintain a distance from the adjacent vehicle in front of the host vehicle sensed by the sensor unit to be a pre-set distance, and configured to return the speed to the target speed.

11. The vehicle control device according to claim 1,
wherein the control unit is configured to decelerate or accelerate a speed to conform to a safe speed of a road where the host vehicle is traveling and then return the speed to the target speed.

12. The vehicle control device according to claim 1,
wherein the control unit is configured to implement at least any one of a smart cruise control (SCC) function or a navigation-based smart cruise control (NSCC) function.

13. A vehicle control method comprising:
determining whether or not at least any one of a smart cruise control (SCC) function or a navigation-based smart cruise control (NSCC) function is being implemented;
in a case where the at least any one of the SCC function or the NSCC function is being implemented, determining whether or not state of charge (SOC) information of a battery is received from a battery management system; and
in a case where reception of the SOC information has failed, adjusting an acceleration level and a deceleration level based on information on a distance to empty (DTE) displayed on an instrument cluster and a charging station distance obtained by a navigation system.

14. The vehicle control method according to claim 13,
wherein adjusting the acceleration level and the deceleration level based on the information on the DTE and a charging station distance includes calculating a first standard value and a second standard value less than the first standard value based on the DTE and the charging station distance, and, based on whether the DTE is less than or equal to the first standard value and exceeds the second standard value, adjusting the acceleration level or the deceleration level to be lower than pre-set values.

15. The vehicle control method according to claim 14, further comprising:
setting the acceleration level and the deceleration level to the pre-set values, based on the DTE exceeding the first standard value.

16. The vehicle control method according to claim 14, further comprising:
issuing a battery shortage warning based on the DTE being equal to or less than the second standard value, and stopping the SCC function and the NSCC function.

17. The vehicle control method according to claim 14, further comprising:
adjusting a regenerative braking amount in accordance with a gradient of a road where a vehicle is traveling, based on the DTE being equal to or less than the first standard value and exceeding the second standard value.

18. The vehicle control method according to claim 17,
wherein adjusting the regenerative braking amount in accordance with the gradient of the road where the vehicle is traveling includes decreasing the regenerative braking amount in accordance with the gradient of the road based on the gradient of the road being an upward gradient, and increasing the regenerative braking amount in accordance with the gradient of the road based on the gradient of the road being a downward gradient.

19. A vehicle comprising:
a navigation system;
an instrument cluster configured to display a distance to empty (DTE); and
a control circuit including one or more non-transitory memories storing computer-readable instructions and one or more processors configured to execute the computer-readable instructions to cause the control circuit to:
determine a driving torque or a regenerative braking torque in accordance with a demand driving force or a demand braking force, and output a torque command according to the driving torque or the regenerative braking torque; and
cause a host vehicle to travel at a target speed, and, based on a speed of the host vehicle being accelerated or decelerated according to a pre-set condition, adjust an acceleration level or a deceleration level based on information on the DTE and a charging station distance.

20. The vehicle according to claim 19, wherein the vehicle further includes a battery management system configured to provide information on a state of charge (SOC) of a battery, and
wherein when executed by the one or more processors, the computer-readable instructions is configured to cause the control circuit to adjust the acceleration level or the deceleration level based on the information on the DTE and the charging station distance, based on whether the control circuit fails to communicate with the battery management system.
